(19) United States
(12) Patent Application Publication
(10) Pub. No.: US 2018/0336794 A1
(43) Pub. Date: Nov. 22, 2018

(54) INTERACTIVE STORIES

(71) Applicant: FUJITSU LIMITED, Kawasaki-shi (JP)

(72) Inventors: Cong CHEN, Cupertino, CA (US); Ajay CHANDER, San Francisco, CA (US); Kanji UCHINO, Santa Clara, CA (US)

(73) Assignee: FUJITSU LIMITED, Kawasaki-shi (JP)

(21) Appl. No.: 15/597,122

(22) Filed: May 16, 2017

(51) Int. Cl. G09B 17/00; H04L 12/58; G09B 7/02; G06F 3/0482

(52) U.S. Cl. CPC G09B 17/006; G06F 3/0482; G09B 7/02; H04L 51/02

(57) ABSTRACT

A method of providing an interactive story is provided. The method may include displaying, via a user interface, a segment of a story including a first virtual character. The method may also include activating a characterbot associated with the first virtual character in response to selection of the first virtual character by a user. Moreover, the method may include receiving, via the user interface, a message from the user directed toward the first virtual character. The method may further include generating, via the characterbot, a response to the received message, and conveying the response via the user interface.

### FIELD

The embodiments discussed herein relate to interactive stories including one or more virtual characters.

### BACKGROUND

Storytelling and/or story reading may provide various benefits for users (e.g., children). For example, storytelling and/or story reading may stimulate social and emotional development of a user, and may enhance a user's imagination, vocabulary, reading, writing, and/or communication skills.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include displaying, via a user interface, a segment of a story including a first virtual character. The method may also include activating a characterbot associated with the first virtual character in response to selection of the first virtual character by a user. Moreover, the method may include receiving, via the user interface, a message from the user directed toward the first virtual character. The method may further include generating, via the characterbot, a response to the received message. In addition, the method may include conveying the response via the user interface.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts an example system that may be used for providing an interactive story;

FIG. 2 is another illustration of an example system that may be used for providing an interactive story;

FIG. 3 illustrates example StoryML code for a portion of an interactive story;

FIG. 4 depicts an example interface that may be used for providing an interactive story;

FIGS. 5A-5C depict social graphs for various segments of a story;

FIG. 6 shows an example flow diagram of a method of providing an interactive story;

FIG. 7 depicts an example flow diagram of a method of generating a character social network;

FIG. 8 depicts an example flow diagram of another method of generating a character social network;

FIG. 9 depicts an example flow diagram of a method of generating one or more character responses;

FIGS. 10A-10E depict user interface screenshots of example scenarios for an interactive story; and

FIG. 11 is a block diagram of an example computing system.

### DESCRIPTION OF EMBODIMENTS

The embodiments discussed herein relate to generating and/or providing interactive stories. Various embodiments may enable a user to converse with one or more virtual characters in a story. In some embodiments, a character's responses may be consistent with the context of the story, including, for example, social relationships and/or a story timeline.

According to various embodiments, a system may include one or more application programs and may be configured to enable a user to, for example, browse, download, read a story, and chat (e.g., via text or voice) with one or more virtual characters in the story. In some embodiments, the system may include a library, which may include stories authored by one or more authors via an authoring tool. Further, the system may include one or more additional application programs, which may be referred to herein as “characterbots”, each of which being associated with a character and configured to respond to a user's message provided to the character. Further, the system may be configured to evaluate a user's interactions with and comprehension of a story.

Various embodiments of the present disclosure may enhance a storytelling and/or story reading experience. For example, various embodiments may immerse a user (also referred to herein as a “reader”) in a story, and may increase reading comprehension. For example, various embodiments may provide for in-story assessment (e.g., via one or more built-in tests). Further, various embodiments may provide conversation-based language and reading assessment (e.g., measure a level of engagement of the user (e.g., based on number of conversations, number of conversational turns in the conversations, a duration of the conversations, and/or reading comprehension (e.g., measure via one or more tests)). A “conservational turn” may happen each time a change in the communicator occurs. In one example wherein a user provides a comment to a character, the characters responds with a question to a user, and the user responds to the character's question with another comment, the number of conversational turns would be equal to three. In another example wherein a character provides a comment to the user, the character provides a question to the user, and the user responds to the question, the number of conversational turns would be equal to two.

Embodiments of the present disclosure will be explained with reference to the accompanying drawings.

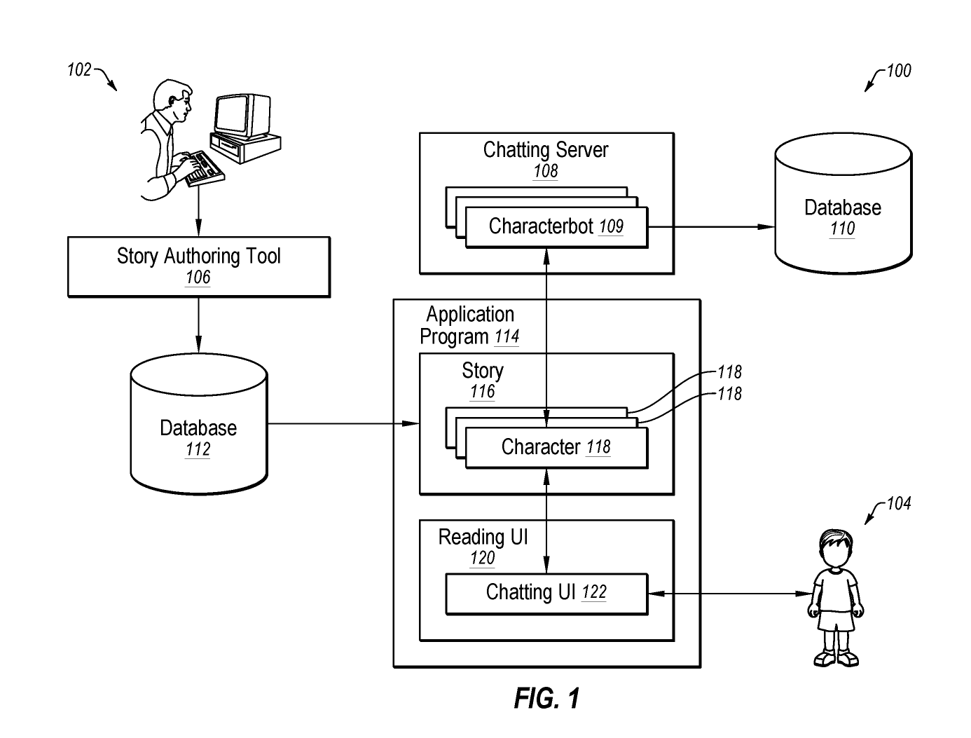

FIG. 1 depicts an example interactive system 100, in accordance with at least one embodiment described herein. System 100 includes an author 102 and a user 104. System 100 further includes an authoring tool 106 (also referred to herein as a “story authoring tool”), a server 108 (also referred to herein as a “chatting server” or a “chat server”), a database 110, and a database 112. As examples, database 110 may include a chat log, and database 112 may include a library of stories (e.g., authored by one or more authors, such as author 102). Database 110 may be local to or remote from server 108.

System 100 further includes an application program 114, which may include a loaded story 116 and a reading user interface 120. In some embodiments, reading user interface 120 may include a chat user interface 122. Story 116 may include one or more characters 118. A story, such as story 116, may include various data, such as text, picture, audio, video, animations, and characters. In some embodiments, a story, which may include a document, may be represented via, for example, a StoryML document. Application program 114 may be local to or remote from database 112 and/or authoring tool 106.

Application program 114, which may also be referred to herein as a “reading application” or “reading app” may enable users to browse, download, and read stories, and chat (e.g., via text and/or voice) with the characters in the stories. For example, application program 114 may enable a user to select and chat with characters via voice and/or text via chat interface 122. Further, input from a user (e.g., a reader) may be conveyed to server 108, which may generate a response to the input and convey the response via chat user interface 122.

Server 108, which may include one or more application programs, may be local to or remote from application program 114. Server 108, and more specifically, one or more application programs of server 108, may manage a collection of characterbots (also referred to herein as “chatbots”) 109. Characterbots 109 may include one or more application programs configured to simulate a conversation between a character and a human user via auditory and/or textual methods. More specifically, characterbot 109 may be configured to generate a response to a comment (also referred to herein as a “message”) submitted by a user (e.g., in a conversation with a character of a story). Authoring tool 106 may include one or more application programs for enabling one or more authors to compose stories (e.g. via one or more StoryML documents).

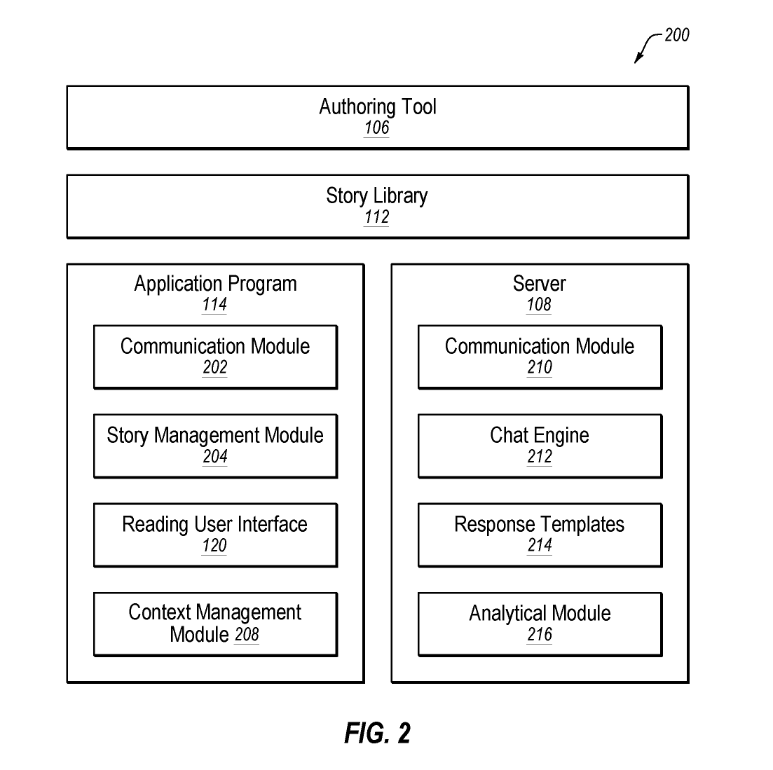

FIG. 2 depicts an example system 200 including authoring tool 106, library 112, application program 114, and server 108. According to the embodiment illustrated in FIG. 2, application program 114 includes a communication module 202, a story management module 116, reading user interface 120, and a context management module 208.

Story management module 204 may be configured to load a story from story library 112. Story management module 204 may further be configured to process programming code (e.g., Story Markup Language) of a story and display the story via reading interface 120. Context management module 208 may be configured to simulate a conversation (e.g., between a character and a user) while conforming to social relationships and timing. Context management module 208 may also be configured to model and/or generate a character social network (e.g., via one or more social graphs). Communication module 202 may be configured to enable application program 114 to transmit and receive data to/from server 108, library 112, and/or a user. Each of story management module 204, reading user interface 120, and context management module 208 will be described more fully below.

Server 108 includes a communication module 210, a chat engine 212, one or more response templates 214, and an analytical module 216. Communication module 210 may be configured to enable server 108 to transmit and receive data to/from database 110 (see FIG. 1) and/or application program 114. Chat engine 212 may be configured to generate one or more responses (e.g., via one or more characterbots). Response templates 214 may include conversation templates for one or more characters of a loaded story. Analytical module 216 may configured to perform conversation analysis, such as measuring user engagement, user language ability, and/or provide in-story assessment (e.g., via one or more tests). Chat engine 212, response templates 214, and analytical module 216 will be described more fully below.

Embodiments of the present disclosure may be implemented via any suitable programming language. For example, according to some embodiments, a Story Markup Language (StoryML) may be used to implement various embodiments of the disclosure. StoryML, which is based on Extensive Markup Language (XML), may define structure and content of a story, and may enable in-story characters to connect to a chatting service (e.g., server 108).

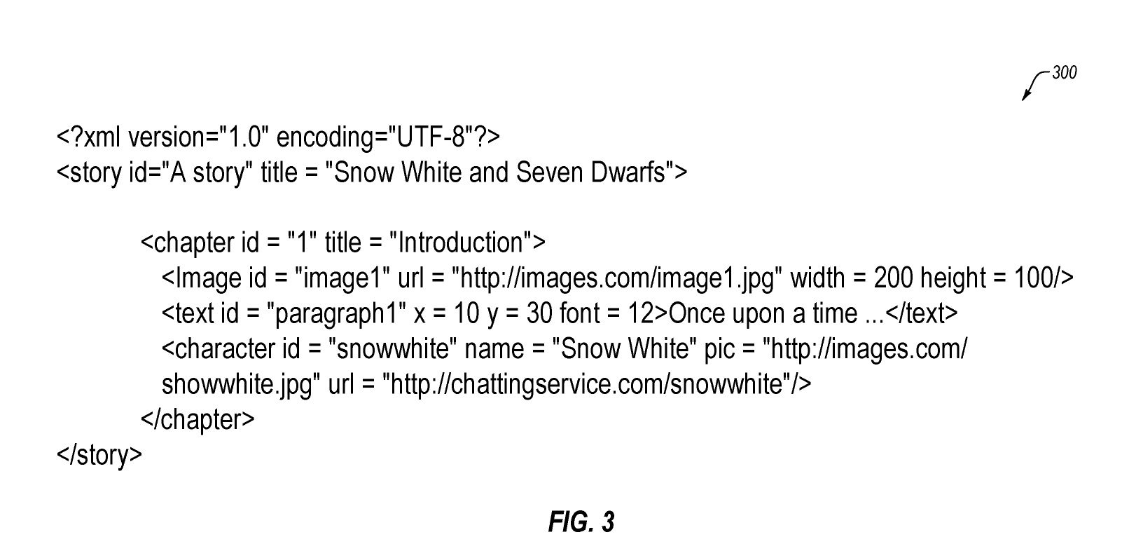

FIG. 3 depicts example StoryML code 300. StoryML code 300 includes a story identification “A story” and a title “Snow White and Seven Dwarfs”. StoryML code 300 further identifies a chapter “1”, which includes a title “Introduction”, an image “image1”, a paragraph “paragaph1”. StoryML code 300 further includes a character “snowwhite” and a URL (“http://chattingservice.com/snowwhite”) for a characterbot for the Snow White character.

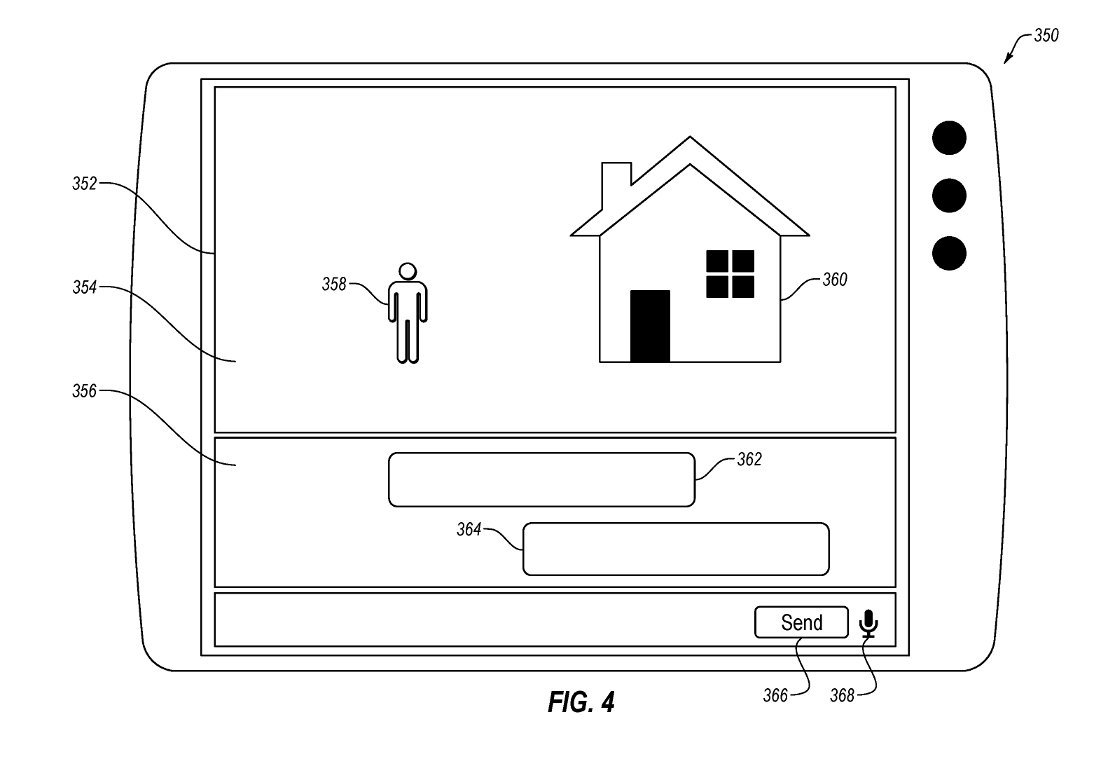

FIG. 4 depicts an example interface 350 including an example reading user interface 352, an example story page 354, and an example chatting user interface 356. Story page 354 may be configured to display contents of a story including, for example one or more characters (e.g., a character 358) and/or one or more objects (e.g., a house 360). According to some embodiments, chatting user interface 356 may include a text box 362, which may be configured for displaying comments from one or more characters of a story. Further, chatting user interface 356 may include text box 364, which may be configured for displaying comments from a user. A user may enter a message via an input device, such as a keyboard or via voice using microphone icon 368. A “Send” button 366 may be used for entering the message provided by the user.

Various challenges may exist in simulating a character's conversation (e.g., conforming to a character's social relationships and a timeline). More specifically, the question “Snow white, who is your favorite dwarf?” may conform to a social relationship due to an association between Snow White and dwarfs. However, the question “Snow white, what is your favorite car?” may not conform to a social relationship due to a lack of association between Snow White and cars. In addition, to conform to a timeline, the question “Snow White, have you met your prince yet?” may be answered differently depending on the time of the question (e.g., chapter 1 of the story versus chapter 10 of the story).

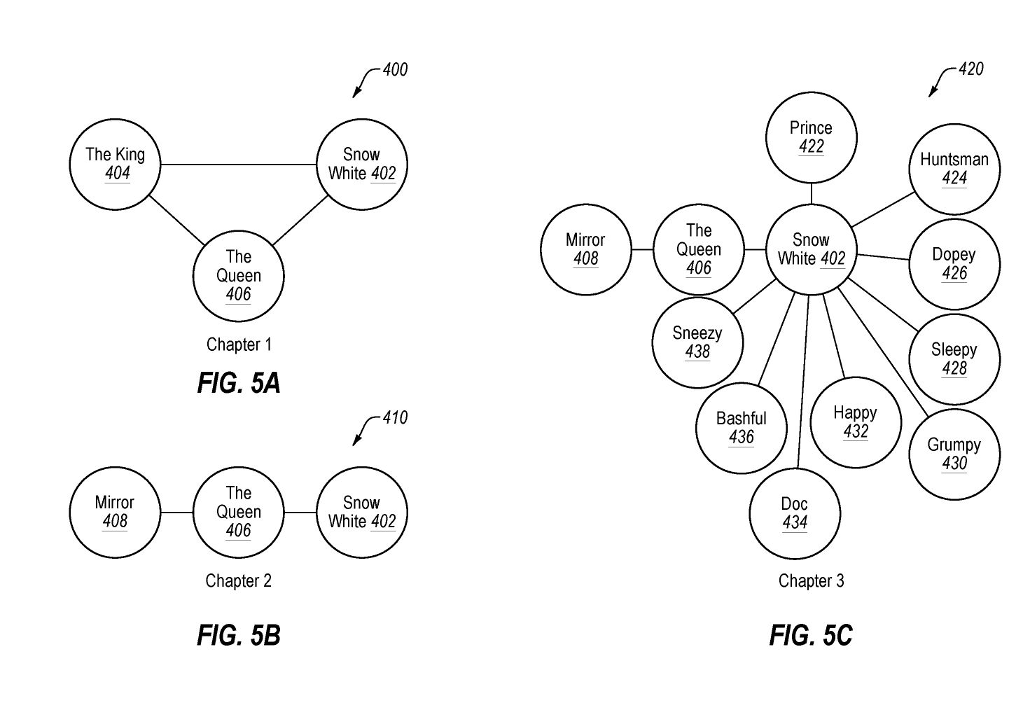

FIGS. 5A-5C depicts various character social graphs for various segments (e.g., chapters) of a story. During, for example, a first segment (e.g., page 1, chapter 1, etc.) of a story, a social graph may be generated. Further, during each subsequent segment, the social graph may be updated. More specifically, FIG. 5A includes a social graph 400, which may represent chapter 1 of the story. Social graph 400 includes three nodes 402, 404, and 406, wherein each node represents character (e.g., Snow White, a King, and a Queen). Social graph 400 indicates that Snow White has a social relationship to the King and the Queen. FIG. 5B includes a social graph 410, which may represent chapter 2 of the story. Social graph 410 includes three nodes 402, 406, and 408, wherein each node represents a character (e.g., Snow White, the Queen, and a Mirror). For example, social graph 410 indicates that the Queen (node 406) has a social relationship with the Mirror (node 408), but Snow White does not have a social relationship with the Mirror.

FIG. 5C includes a social graph 420, which may represent chapter 3 of the story. Social graph 430 includes nodes 402, 406, 408, 422, 424, 426, 428, 430, 432, 434, 436, and 438, wherein each node represents a character. For example, social graph 420 indicates that the Prince (node 422) has a social relationship to Snow White (node 402), but the Prince does not have a social relationship to Grumpy (node 430).

An “edge” of a social graph may indicate a social relationship between two characters. Further, in some embodiments, a weight of edge may be used to determine the strength of the relationship. For example, a weight of an edge between two characters may be based on a number of times the two characters appear together in a story segment and/or a number of conversation occurrences (e.g., in the story) between the two characters. In some embodiments, a social graph may be updated at every segment (e.g., chapter, section, or page) of the story. A social graph may be used determine social relationships and how to respond to a question about other characters based on the characters' social relationships.

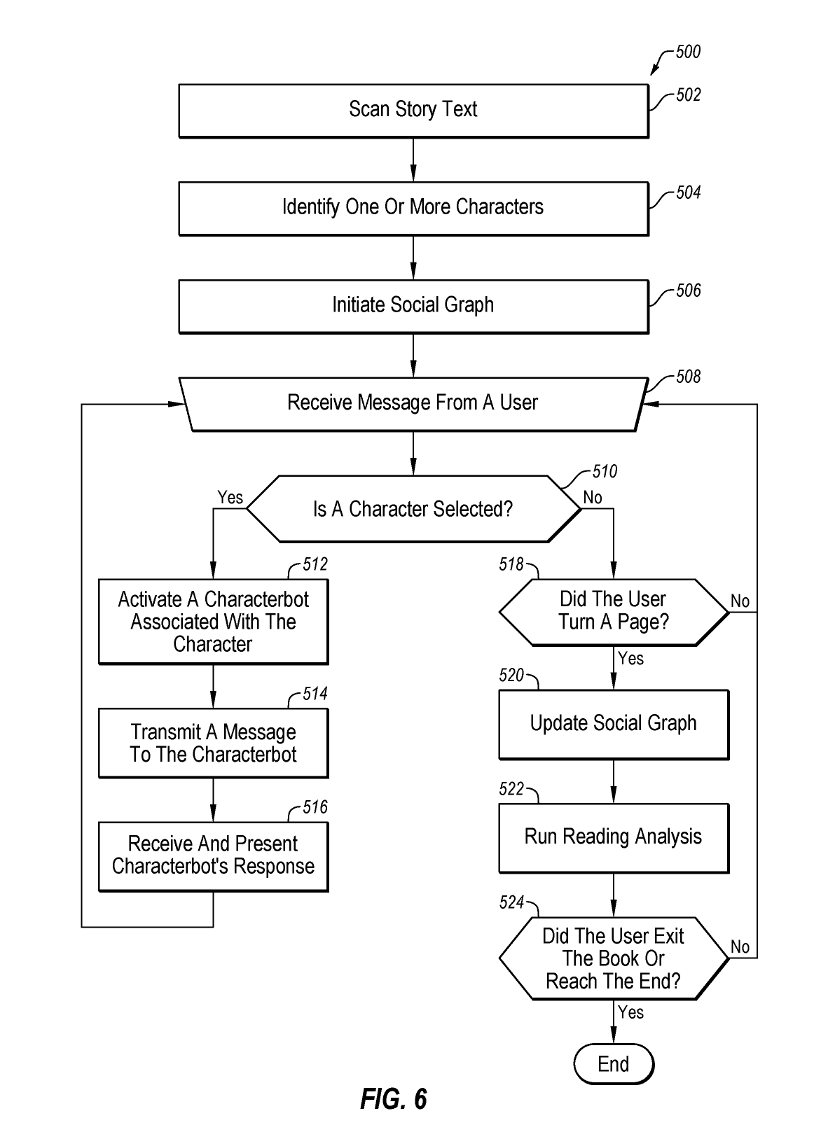

FIG. 6 shows an example flow diagram of a method 500 of operating an interactive story including one or more characters, arranged in accordance with at least one embodiment described herein. Although illustrated as discrete blocks, various blocks may be divided into additional blocks, combined into fewer blocks, or eliminated, depending on the desired implementation.

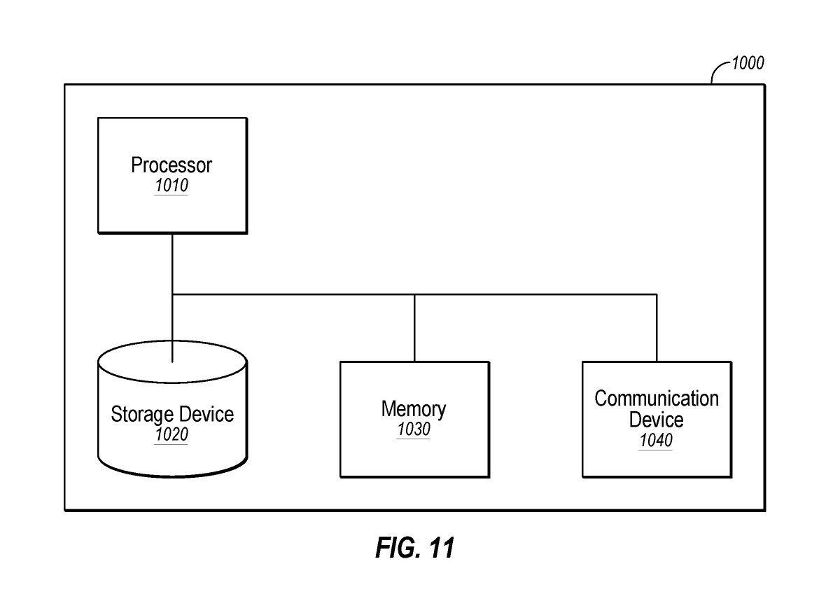

In some embodiments, method 500 may be performed by one or more devices, such system 100 of FIG. 1, system 200 of FIG. 2, and/or system 1000 of FIG. 11. For instance, processing device 1020 of FIG. 11 may be configured to execute computer instructions stored on memory 1030 to perform functions and operations as represented by one or more of the blocks of method 500.

Method 500 may begin at block 502. At block 502, text of a story may be scanned, and method 500 may proceed to block 504. For example, reading user interface 120 of FIG. 1, upon receipt of a story (e.g., story 116), may scan one or more pages of the story.

At block 504, one or more characters of the story may be identified, and method 500 may proceed to block 506. For example, reading user interface 120 of FIG. 1 may, via, for example, the scanning operation performed at block 502, identify one or more characters in the story.

At block 506, a social graph may be initiated, and method 500 may proceed to block 508. For example, reading user interface 120 of FIG. 1 may initiate a social graph for the story (e.g., for the first page of the story, the first chapter of the story, etc.).

At block 508, a message from a user may be received, and method 500 may proceed to block 510. For example, the message, which may be provided by a user via text or voice, may be received via reading user interface 120 of FIG. 1.

At block 510, a determination may be made as to whether a character has been selected. For example, reading user interface 120 may be configured to determine whether the user has selected (e.g., via “tapping” or “clicking on”) a character displayed in a user interface (e.g., reading user interface 352; see FIG. 4) and/or a story page (e.g. story page 354; see FIG. 4). If a character has been selected, method 500 may proceed to block 512. If a character has not been selected, method 500 may proceed to block 518.

At block 512, a characterbot associated with the selected character may be activated, and method 500 may proceed to block 514. For example, reading user interface 120 of FIG. 1 may cause a characterbot (e.g., characterbot 109 of chatting server 108; see FIG. 1) to be activated.

At block 514, the message may be transmitted to the activated characterbot, and method 500 may proceed to block 516. For example, the message (e.g., the input provided by the user) may be transmitted from reading user interface 120 (see FIG. 1) to characterbot 109 of chatting server 108 of FIG. 1.

At block 516, a response from the activated characterbot may be received and presented, and method 500 may return to block 508. More specifically, for example, a response sent from characterbot 109 may be received and displayed via a user interface (e.g., reading user interface 352; see FIG. 4) and/or a story page (e.g. story page 354; see FIG. 4).

At block 518, a determination may be made as to whether the story has been advanced (e.g., via a user turning a page of the story). For example, reading user interface 120 of FIG. 1 may determine whether the story has been advanced to the next segment. If the story has been advanced, method 500 may proceed to block 520. If the story has not been advanced, method 500 may return to block 508.

At block 520, the social graph may be updated, and method 500 may proceed to block 522. For example, reading user interface 120 of FIG. 1 may update the social graph based on the current segment (e.g., page, chapter, ect.) of the story.

At block 522, a reading analysis may be initiated, and method 500 may proceed to block 524. For example, application program 114, and more specifically, reading user interface 120 may perform conversation analysis, such as measuring user engagement (e.g., based on number of conversations, number of conversational turns in the conversations, a duration of the conversations, and/or reading comprehension (e.g., via one or more tests)), user language ability (e.g., the user's vocabulary, pronunciation, syntax, sentence structure), and/or providing in-story assessment (e.g., via one or more tests).

At block 524, a determination may be made as to whether the user has either exited the story (e.g., closed the book) or reached an end of the story. For example, reading user interface 120 (see FIG. 1) may determine whether the user has either exited the story (e.g., closed the book) or reached an end of the story. If it is determined that the user has either exited the story or reached an end of the story, method 500 may end. If it is determined that the user has neither exited the story nor reached the end of the story, method 500 may return to block 508.

Modifications, additions, or omissions may be made to method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

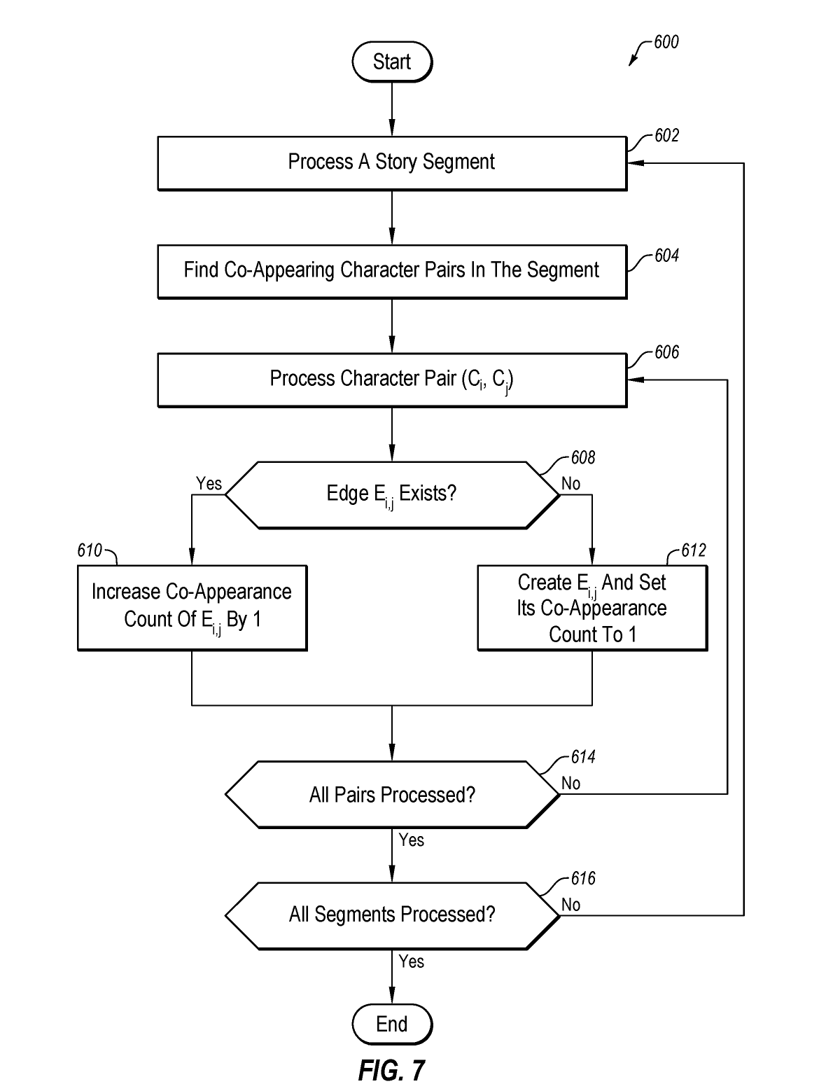

FIG. 7 shows an example flow diagram of a method 600 of generating a character social network, arranged in accordance with at least one embodiment described herein. Although illustrated as discrete blocks, various blocks may be divided into additional blocks, combined into fewer blocks, or eliminated, depending on the desired implementation.

In some embodiments, method 600 may be performed by one or more devices, such as system 100 of FIG. 1, system 200 of FIG. 2, and/or system 1000 of FIG. 11. For instance, processing device 1020 of FIG. 11 may be configured to execute computer instructions stored on memory 1030 to perform functions and operations as represented by one or more of the blocks of method 600.

Method 600, which may be used to, for example, create one or more social relationship edges based on character co-appearance, may begin at block 602. At block 602, a segment of a story may be processed, and method 600 may proceed to block 604. For example, a segment (e.g., a chapter of the story, a page of the story, etc.) of story 116 (see FIG. 1) may be processed by context management module 208 of FIG. 2.

At block 604, one or more co-appearing character pairs in the segment may be identified, and method 600 may proceed to block 606. For example, via processing the story (e.g., as performed at block 602), context management module 208 of FIG. 2 may identify one or more character pairs in the segment (e.g., two characters appearing together in the segment).

At block 606, an identified co-appearing character pair may be processed, and method 600 may proceed to block 608. For example, context management module 208 of FIG. 2 may process an identified character pair (e.g., character Cᵢ, character Cⱼ). More specifically, for example, context management module 208 of FIG. 2 may process the identified character pair (e.g., character Cᵢ, character Cⱼ) to determine a relationship between the two characters in the identified character pair.

At block 608, a determination may be made as to whether an edge E_{i,j} between the processed character pair exists. For example, context management module 208 of FIG. 2 may determine whether the edge E_{i,j} exists between the processed character pair. If it is determined that an edge between the processed character pair exists, method 600 may proceed to block 610. If it is determined that an edge between the processed character pair does not exist, method 600 may proceed to block 612.

At block 610, a co-appearance count of edge E_{i,j} may be increased (e.g., by one (1)), and method 600 may proceed to block 614. For example, context management module 208 of FIG. 2 may increase a co-appearance count of edge E_{i,j}.

At block 612, edge E_{i,j} may be created and a co-appearance count for edge E_{i,j} may be set equal to a variable number (e.g., one (1)), and method 600 may proceed to block 614. For example, context management module 208 of FIG. 2 may set a co-appearance count of edge E_{i,j} equal to the variable number (e.g., one (1)).

At block 614, a determination may be made as to whether all character pairs in the story segment have been processed. For example, context management module 208 of FIG. 2 may determine whether all character pairs in the segment have been processed. If all characters pairs in the segment have been processed, method 600 may proceed to block 616. If all character pairs in the segment have not been processed, method 600 may return to block 606.

At block 616, a determination may be made as to whether all segments of the story have been processed. For example, context management module 208 of FIG. 2 may determine whether all segments of the story have been processed. If all segments of the story have been processed, method 600 may end. If all segments of the story have not been processed, method 600 may return to block 602.

Modifications, additions, or omissions may be made to method 600 without departing from the scope of the present disclosure. For example, the operations of method 600 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

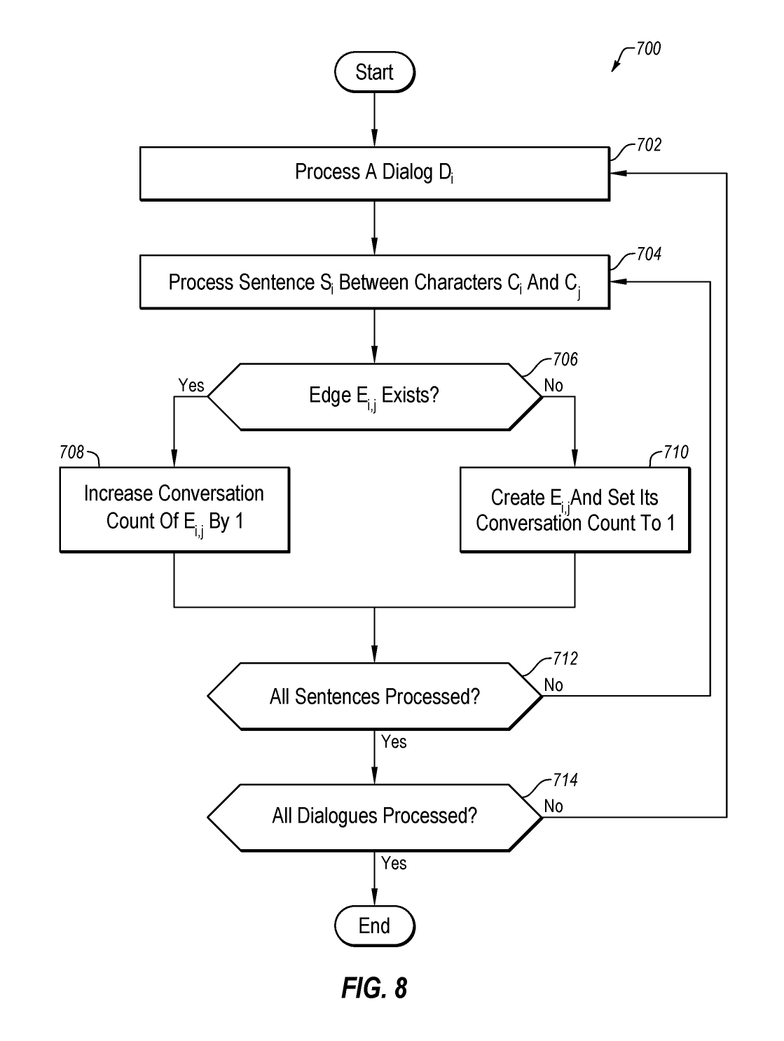

FIG. 8 shows an example flow diagram of a method 700 of generating a character social network, arranged in accordance with at least one embodiment described herein. Although illustrated as discrete blocks, various blocks may be divided into additional blocks, combined into fewer blocks, or eliminated, depending on the desired implementation.

In some embodiments, method 600 may be performed by one or more devices, such as system 100 of FIG. 1, system 200 of FIG. 2, and/or system 1000 of FIG. 11. For instance, processing device 1020 of FIG. 11 may be configured to execute computer instructions stored on memory 1030 to perform functions and operations as represented by one or more of the blocks of method 700.

Method 700, which may be used to, for example, create one or more social relationship edges based on conversations, may begin at block 702. At block 702, a dialogue Dᵢ of a story may be processed, and method 700 may proceed to block 704. For example, the dialogue Dᵢ between two characters (e.g., character Cᵢ, character Cⱼ) in the story may processed via context management module 208 of FIG. 2.

At block 704, a sentence Sᵢ between two characters of the story may be processed and method 700 may proceed to block 706. For example, sentence Sᵢ between characters Cᵢ and Cⱼ of the story may be processed via context management module 208 of FIG. 2.

At block 706, a determination may be made as to whether an edge E_{i,j} between the two characters exists. For example, context management module 208 of FIG. 2 may determine whether an edge exists between the two characters. If it is determined that an edge between the two characters exists, method 700 may proceed to block 708. If it is determined that an edge between the two characters does not exist, method 700 may proceed to block 710.

At block 708, a conversation count of edge E_{i,j} may be increased (e.g., by one (1)), and method 700 may proceed to block 712. For example, context management module 208 of FIG. 2 may increase a conversation count of edge E_{i,j}.

At block 710, edge E_{i,j} may be created and a conversation count for edge E_{i,j} may be set equal to a variable number (e.g., one (1)), and method 700 may proceed to block 712. For example, context management module 208 of FIG. 2 may set a conversation count of edge E_{i,j} equal to the variable number (e.g., one (1)).

At block 712, a determination may be made as to whether all sentences in dialogue Dᵢ have been processed. For example, context management module 208 of FIG. 2 may determine whether all sentences in dialogue Dᵢ have been processed. If all sentences in dialogue Dᵢ have been processed, method 700 may proceed to block 714. If all sentences in dialogue Dᵢ have not been processed, method 700 may return to block 704.

At block 714, a determination may be made as to whether each dialogue in the story has been processed. For example, context management module 208 of FIG. 2 may determine whether each dialogue of the story have been processed. If each dialogue of the story has been processed, method 700 may end. If each dialogue of the story has not been processed, method 700 may return to block 702.

Modifications, additions, or omissions may be made to method 700 without departing from the scope of the present disclosure. For example, the operations of method 700 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

According to various embodiments, characterbots (e.g., characterbots 109 of FIG. 1) may understand context and may understand their roles and time in a story. A system (e.g., system 100) may include a conservation database (e.g., including one or more response templates) for each character in a story. Response templates 214 (see FIG. 2) may include one or more templates for each character of a story. According to some embodiments, response templates may be selected based on character relationships and/or a story timeline.

For example, a user may input a message “who is your favorite [character name]?” If the [character name] is known (e.g., [character name]=“dwarf”), a known character response may be generated and provided to the user. In this example, a known character response may include, for example, “Happy! Who's not happy for Happy?” or “I think Grumpy is hilarious.” In some embodiments, a known character response may be randomly selected from a plurality of known character responses. If the [character name] is not known, an unknown character response may be generated. In this example, an unknown character response may include, for example, “Who is [character name]?” or “I don't know [character name].”

As noted herein, response templates may be selected based on time (e.g., a response to a message from a user in chapter 1 of a story may be different than a response to the same message in chapter 5). More specifically, a user may input a message “would you like an apple?” In one example, if the message is received between chapters 1 and 3 of the story, a response may be “Yes, apples are my favorite.” However, if the message is received in chapter 4 or beyond, the response may be “no, not again” or “only if it is not poisoned.”

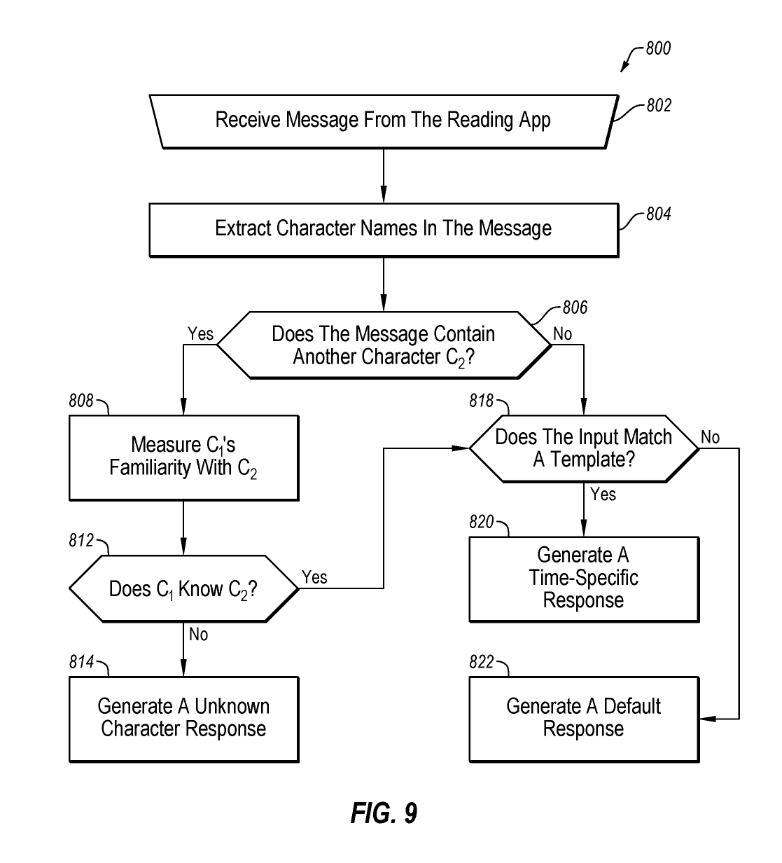

FIG. 9 shows an example flow diagram of a method 800 of generating one or more characters responses, arranged in accordance with at least one embodiment described herein. Although illustrated as discrete blocks, various blocks may be divided into additional blocks, combined into fewer blocks, or eliminated, depending on the desired implementation.

In some embodiments, method 800 may be performed by one or more devices, such as system 100 of FIG. 1, system 200 of FIG. 1, and/or system 1000 of FIG. 11. For instance, processing device 1020 of FIG. 11 may be configured to execute computer instructions stored on memory 1030 to perform functions and operations as represented by one or more of the blocks of method 800.

Method 800 may begin at block 802. At block 802, a message may be received, and method 800 may proceed to block 804. For example, the message, which may be provided by a user and sent from application program 114 of FIG. 1, may be received at chat engine 212 (see FIG. 2). Further, for example, the message may be associated with a first character c₁ (e.g., as selected by the user), which may be associated with a characterbot.

At block 804, one or more character names in the received message may be extracted. For example, the received message may be parsed (e.g., by chat engine 212 (see FIG. 2)) to extract one or more character names.

At block 806, a determination may be made as to whether the received message includes a second character name (e.g., for a second character c₂) in addition to a first character name for first character C₁. For example, chat engine 212 (see FIG. 2) may determine whether the received message includes the second character name (e.g., for a second character C₂) in addition to the character name for first character C₁. If the message does not include the second character name, method 800 may proceed to block 818. If the message includes the second character name, method 800 may proceed to block 808.

At block 808, the familiarity between the first character C₁ and the second character C₂ may be measured. For example, based on stored data (e.g., a social graph), chat engine 212 (see FIG. 2) may measure the familiarity between the first character C₁ and the second character C₂.

At block 812, a determination may be made as to whether first character C₁ is familiar with second character C₂. For example, chat engine 212 (see FIG. 2) may determine whether first character C₁ is familiar with second character C₂. In some embodiments, determining whether first character C₁ is familiar with second character C2 may include determining whether an edge exists, and possibly a weight of the edge, between first character C₁ and second character C₂ in a social graph. If first character C₁ is familiar with second character C₂, method 800 may proceed to block 816. If first character C₁ is not familiar with second character C₂, method 800 may proceed to block 814.

At block 814, an unknown character response may be generated. For example, chat engine 212 (see FIG. 2) may generate an unknown character response. The unknown character response may be conveyed via a user interface (e.g., chatting user interface 122 of FIG. 1).

At block 818, a determination may be made as to whether the message matches at least one response template for character C₁. For example, chat engine 212 of FIG. 2 may determine whether the message matches at least one template (e.g., stored within a conversation databased for character C₁). If the input matches a template, method 800 may proceed to block 820, wherein a time-specific response may be generated. If the input does not match a template, method 800 may proceed to block 822 wherein a default response may be generated. Responses, such as a time-specific response and a default response, may be conveyed via a user interface (e.g., chatting user interface 122 of FIG. 1).

Modifications, additions, or omissions may be made to method 800 without departing from the scope of the present disclosure. For example, the operations of method 800 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

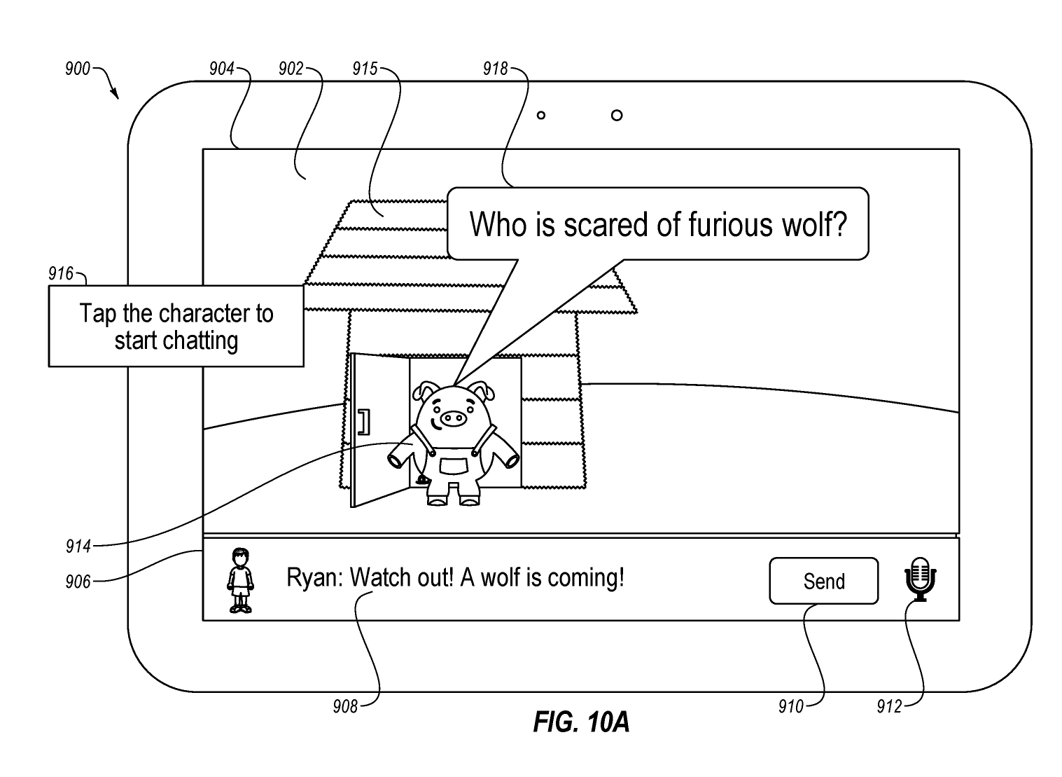

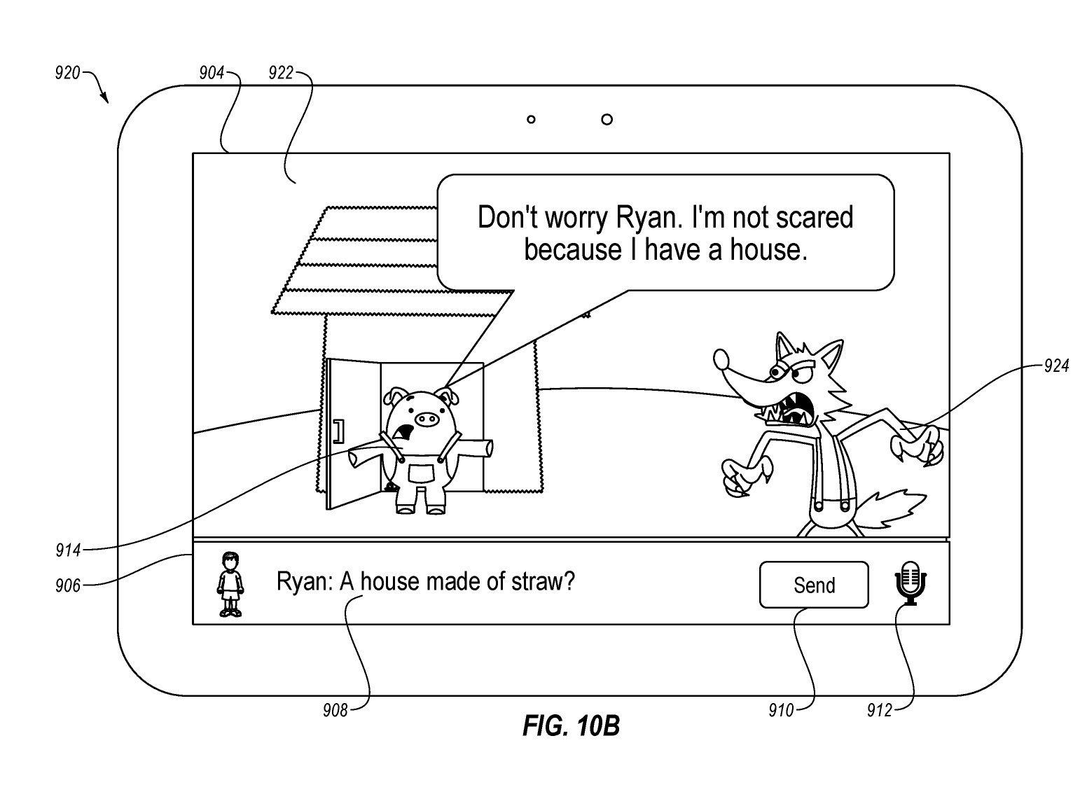

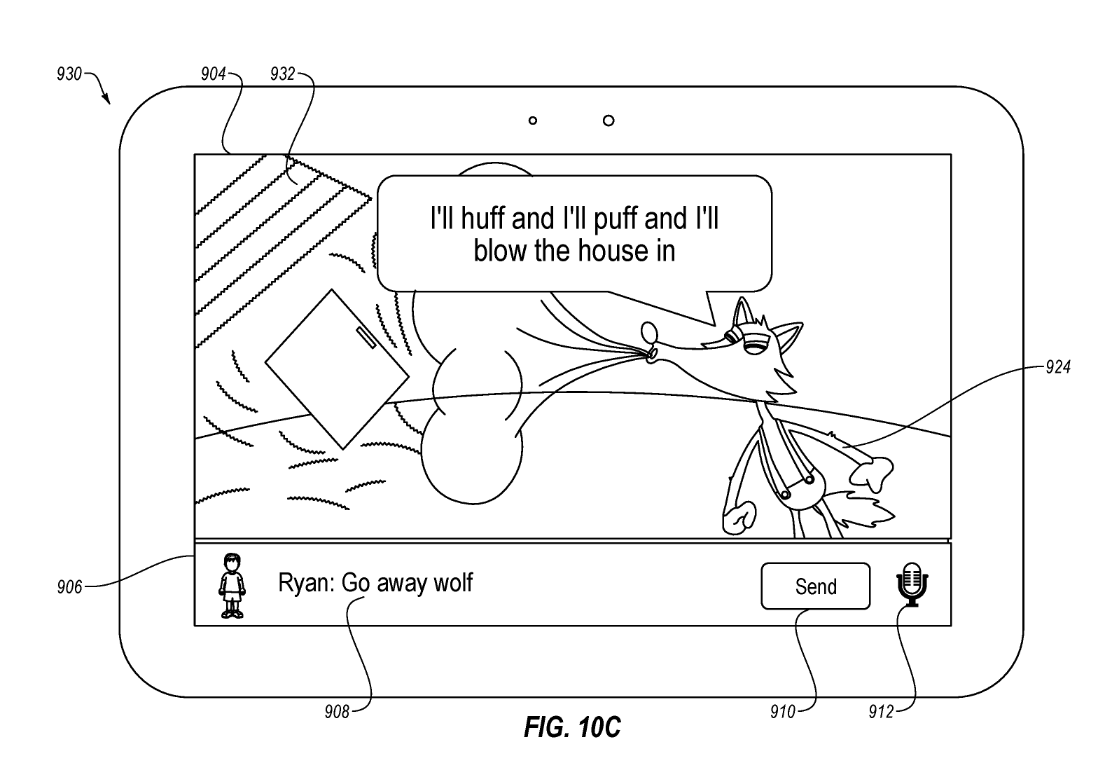

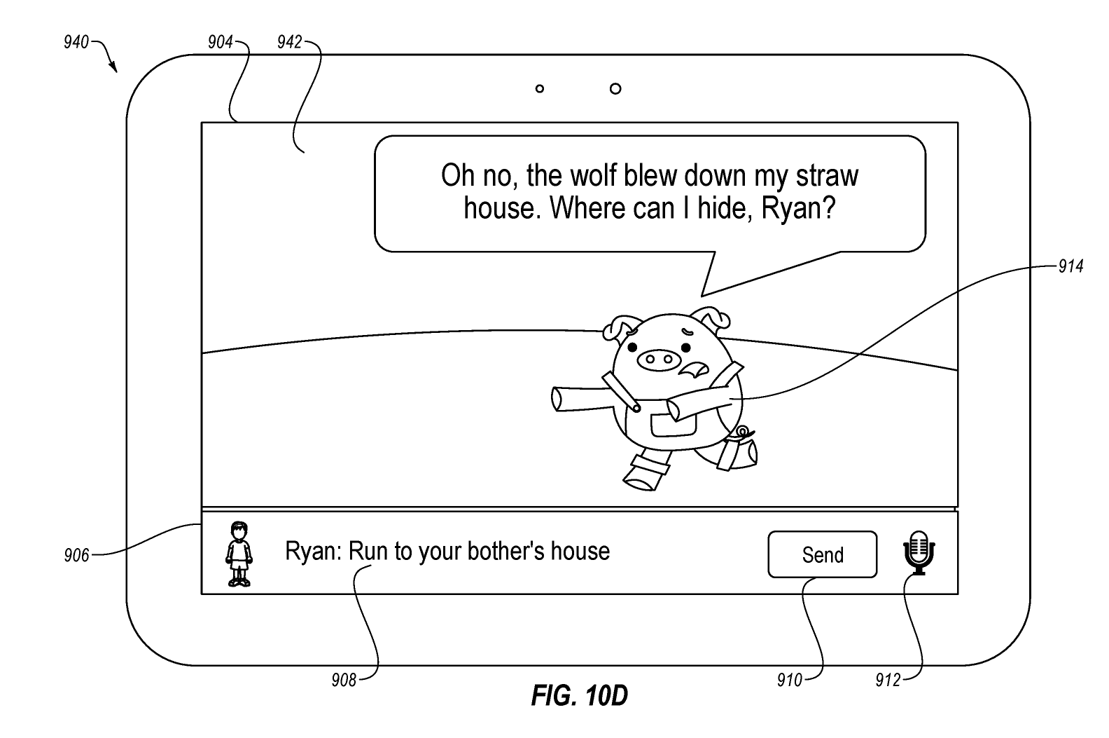

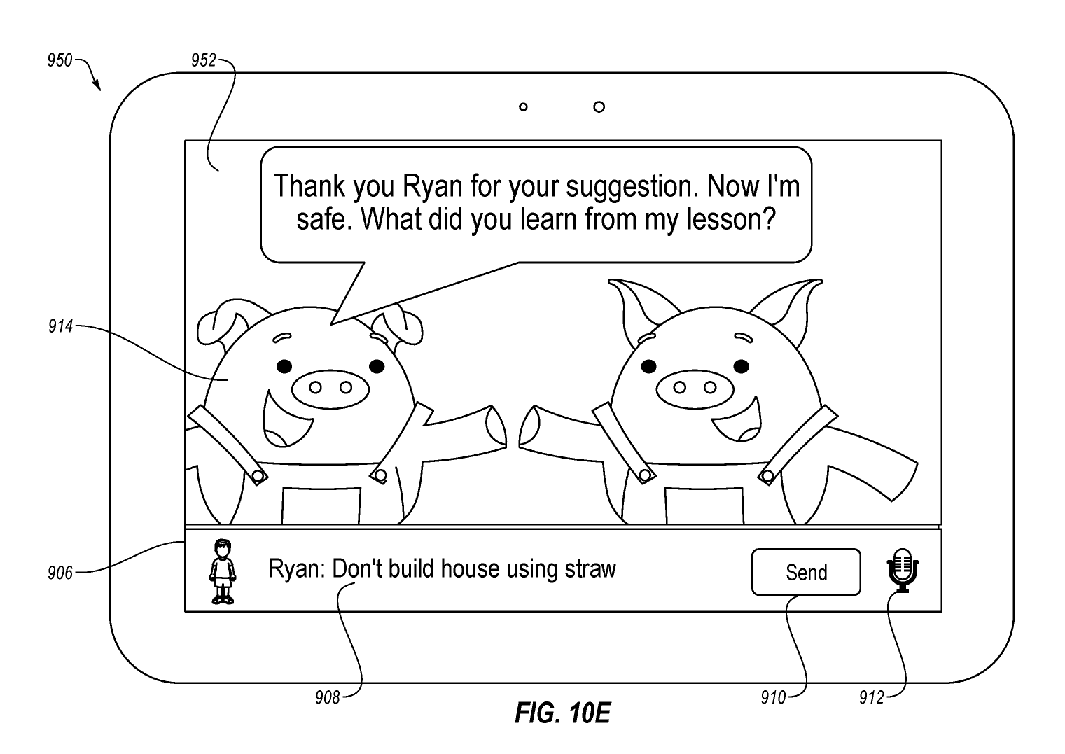

FIGS. 10A-10E depict, via various interface screenshots, an example scenario involving a story related to the “Three Little Pigs” and a user “Ryan” who interacts with the story. With reference to FIG. 10A, a screenshot 900 depicts a page 902 of a story displayed via a reading interface 904. Page 902 depicts a character 914 and a house 915. Further, a chatting interface 906, including a user text box 908, is shown. Chatting interface 906 further includes a “Send” button 910 and a microphone icon 912. A user (e.g., in this example, “Ryan”) may enter a message via an input device, such as a keyboard or via voice using microphone icon 912. The text may be submitted via the Send button 910. In some embodiments, text submission may not be required. Rather, a user may simple voice his/her comments (messages) to chatting interface 906.

During operation, a user may initiate character interaction via, for example, selecting (e.g., double clicking on, tapping on, or the like) character 914 displayed on page 902. For example, as provided in instruction 916, the user may “tap” on the pig displayed on page 902. In one example, the user has provided a comment (e.g., “Watch out? A wolf is coming!”). Further, for example, character 914 (e.g., the pig) may respond with a comment (e.g., “Who is scared of furious wolf?”). It is noted that comments provided by characters and users may be verbal and/or textual.

FIG. 10B illustrates another screenshot 920 depicting a page 922 of the story in reading interface 904. In addition to character 914, page 920 depicts a character 924 (e.g., a wolf). In page 922, character 914 has provided a comment (e.g., “Don't worry Ryan. I'm not scared because I have a house.”). Further, the user may respond with a comment (e.g., “A house made of straw?”).

FIG. 10C depicts another screenshot 930 depicting a page 932 of the story in reading interface 904. In page 932, character 924, which is depicted blowing the house down, has provided a comment (e.g., “I'll huff and I'll puff and I'll blow the house in”). Further, the user has provided a comment (e.g., “Go away wolf”).

FIG. 10D depicts another screenshot 940 depicting a page 942 of the story in reading interface 904. In page 942, character 914 has provided a comment including a question for the user (e.g., “Oh no, the wolf blew down my straw house. Where can I hide, Ryan?”). Further, in response to the question from character 914, the user has provided a comment (e.g., “Run to your brother's house”).

FIG. 10E illustrates yet another screenshot 950 depicting a page 952 of the story in reading interface 904. In page 952, character 914 has provided a comment including another question for the user (e.g., “Thank you Ryan for your suggestion. Now I'm safe. What did you learn from my lesson?”). Further, in response to the question from character 914, the user has provided a comment (e.g., “don't build house using straw”).

Various embodiments may provide for in-story assessment (e.g., via one or more built-in tests). Further, various embodiments may provide conversation-based language and reading assessment (e.g., measure a level of engagement of the user (e.g., based on number of conversations, number of conversational turns in the conversations, a duration of the conversations, and/or reading comprehension (e.g., measured via one or more tests)). Further, some embodiments may include measuring a user's language skills (e.g., the user's vocabulary, pronunciation, syntax, sentence structure, etc.). Moreover, according to some embodiments, a story may include one or more embedded questions (e.g., for testing a user's reading comprehension and/or the user's degree of learning (e.g., how much and/or what the user learned from the story).

A question may be provided to the user. For example, a question such as “what did you learn from my lesson?” may be provided to the user. In response to the question, the user may submit an answer (e.g., “Don't build a house using straw”). Further, the user's answer may be compared with an expected answer (e.g., “use stronger material to build a house”). Moreover, the user's answer may be rated based on vocabulary used, articulation, and/or semantics. Further, one or more scores for the user may be generated based on, for example, a correctness of the user's answer, the user's vocabulary, articulation, and/or semantics.

Various embodiments disclosed herein may be used for teaching (e.g., language, social skills, etc.) and/or communicating with users (e.g., children) to, for example, correct behavior problems with users. Various embodiments may be integrated in various digital books, toys, or other devices. Further, some embodiments may be utilized for generating story-based job training systems including conversation functionality and analysis.

FIG. 11 is a block diagram of an example computing device 1000, in accordance with at least one embodiment of the present disclosure. For example, system 100 (see FIG. 1), system 200 (see FIG. 2), or one or more components thereof, may be implemented as computing device 1000. Computing device 1000 may include a desktop computer, a laptop computer, a server computer, a tablet computer, a mobile phone, a smartphone, a personal digital assistant (PDA), an e-reader device, a network switch, a network router, a network hub, other networking devices, or other suitable computing device.

Computing device 1000 may include a processor 1010, a storage device 1020, a memory 1030, and a communication device 1040. Processor 1010, storage device 1020, memory 1030, and/or communication device 1040 may all be communicatively coupled such that each of the components may communicate with the other components. Computing device 1000 may perform any of the operations described in the present disclosure.

In general, processor 1010 may include any suitable special-purpose or general-purpose computer, computing entity, or processing device including various computer hardware or software modules and may be configured to execute instructions stored on any applicable computer-readable storage media. For example, processor 1010 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 11, processor 1010 may include any number of processors configured to perform, individually or collectively, any number of operations described in the present disclosure.

In some embodiments, processor 1010 may interpret and/or execute program instructions and/or process data stored in storage device 1020, memory 1030, or storage device 1020 and memory 1030. In some embodiments, processor 1010 may fetch program instructions from storage device 1020 and load the program instructions in memory 1030. After the program instructions are loaded into memory 1030, processor 1010 may execute the program instructions.

For example, in some embodiments one or more of the processing operations of a device and/or system (e.g., an application program, a server, etc.) may be included in data storage 1020 as program instructions. Processor 1010 may fetch the program instructions of one or more of the processing operations and may load the program instructions of the processing operations in memory 1030. After the program instructions of the processing operations are loaded into memory 1030, processor 1010 may execute the program instructions such that computing device 1000 may implement the operations associated with the processing operations as directed by the program instructions.

Storage device 1020 and memory 1030 may include computer-readable storage media for carrying or having computer-executable instructions or data structures stored thereon. Such computer-readable storage media may include any available media that may be accessed by a general-purpose or special-purpose computer, such as processor 1010. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 1010 to perform a certain operation or group of operations.

In some embodiments, storage device 1020 and/or memory 1030 may store data associated with an interactive storybook system. For example, storage device 1020 and/or memory 1030 may store stories, character data, chat logs, conversation data, social graphs, or any data related to an interactive story book system.

Communication device 1040 may include any device, system, component, or collection of components configured to allow or facilitate communication between computing device 1000 and another electronic device. For example, communication device 1040 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication device 1040 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to FIG. 11 without departing from the scope of the present disclosure. For example, computing device 1000 may include more or fewer elements than those illustrated and described in the present disclosure. For example, computing device 1000 may include an integrated display device such as a screen of a tablet or mobile phone or may include an external monitor, a projector, a television, or other suitable display device that may be separate from and communicatively coupled to computing device 1000.

As used herein, the terms “module” or “component” may refer to specific hardware implementations configured to perform the operations of the module or component and/or software objects or software routines that may be stored on and/or executed by, for example, authoring tool 106, server 108, and/or application program 114. In some embodiments, the different components and modules described herein may be implemented as objects or processes that execute on a computing system (e.g., as separate threads). While some of the system and methods described herein are generally described as being implemented in software (stored on and/or executed by device 1000), specific hardware implementations or a combination of software and specific hardware implementations are also possible and contemplated. In this description, a “computing entity” may include any computing system as defined herein, or any module or combination of modules running on a computing device, such as device 1000.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
displaying, via a user interface, a segment of a story including a first virtual character;
activating a characterbot associated with the first virtual character in response to a selection of the first virtual character by a user;
receiving, via the user interface, a message from the user directed to the first virtual character;
generating, via the characterbot, a response to the received message; and
conveying the response via the user interface.

2. The method of claim 1, further comprising activating a chat interface in response to selection by the user of the first virtual character.

3. The method of claim 1, wherein generating a response comprises:
determining that the message references a second virtual character; and
determining whether the second virtual character has a relationship with the first virtual character via a social graph;
wherein the response comprises:
an unknown character response in response to the second virtual character not having a relationship with the first virtual character; and
one of a time-specific response and a default response in response to the second virtual character having a relationship with the first virtual character.

4. The method of claim 1, wherein generating a response comprises generating a time-specific response if one or more response templates for the first virtual character matches the message, else generating a default response.

5. The method of claim 1, further comprising transmitting the message to a chat server including the characterbot.

6. The method of claim 1, further comprising:
generating a social graph for the first virtual character and at least a second virtual character; and
updating the social graph in response to advancement of the story.

7. The method of claim 1, further comprising generating a score for the user based on at least one of: a number of conversations between the user and at least the first virtual character; a number of conversational turns in one or more conversations between the user and at least the first virtual character; and an answer submitted by the user in response to a provided test question.

8. A system, comprising:
one or more processors configured to:
display, via a user interface, a segment of a story including a first virtual character;
activate a characterbot associated with the first virtual character in response to selection of the first virtual character by a user;
receive a message directed toward the first virtual character;
generate, via the characterbot, a response to the received message; and
convey the response via the user interface.

9. The system of claim 8, wherein the one or more processors are further configured to activate a chat interface in response to selection by the user of the first virtual character.

10. The system of claim 8, wherein the one or more processors are further configured to:
determine that the message references a second virtual character; and
determine whether the second virtual character has a relationship with the first virtual character via a social graph;
wherein the response comprises:
an unknown character response in response to the second virtual character not having a relationship with the first virtual character; and
one of a time-specific response and a default response in response to the second virtual character having a relationship with the first virtual character.

11. The system of claim 8, wherein the one or more processors are further configured to generate a time-specific response if one or more response templates for the first virtual character matches the message, else generate a default response.

12. The system of claim 8, wherein the one or more processors are configured to transmit the message to a chat server including the characterbot to generate the response.

13. The system of claim 8, wherein the one or more processors are further configured to:
generate a social graph for the first virtual character and at least a second virtual character; and
update the social graph in response to advancement of the story.

14. The system of claim 8, wherein the one or more processor are further configured to generate a score for the user based on at least one of: a number of conversations between the user and at least the first virtual character; a number of conversational turns in one or more conversations between the user and at least the first virtual character; and an answer submitted by the user in response to a provided test question.

15. A non-transitory computer-readable medium having computer instructions stored thereon that are executable by a processing device to perform or control performance of operations comprising:
displaying via a user interface a segment of a story including a first virtual character;
activating a characterbot associated with the first virtual character in response to selection of the first virtual character by a user;
receiving, via the user interface, a message from the user directed toward the first virtual character;
generating, via the characterbot, a response to the received message; and
conveying the response via the user interface.

16. The non-transitory computer-readable medium of claim 15, the operations further comprising:
determining that the message references a second virtual character; and
determining whether the second virtual character has a relationship with the first virtual character via a social graph;
wherein the response comprises:
an unknown character response in response to the second virtual character not having a relationship with the first virtual character; and
one of a time-specific response and a default response in response to the second virtual character having a relationship with the first virtual character.

17. The non-transitory computer-readable medium of claim 16, wherein generating a response comprises generating a time-specific response if one or more response templates for the first virtual character matches the message, else generating a default response.

18. The non-transitory computer-readable medium of claim 15, the operations further comprising:
generating a social graph for the first virtual character and at least a second virtual character; and
updating the social graph in response to advancement of the story.

19. The non-transitory computer-readable medium of claim 15, the operations further comprising generating a score for the user based on at least one of: a number of conversations between the user and at least the first virtual character; a number of conversational turns in one or more conversations between the user and at least the first virtual character; and an answer submitted by the user in response to a provided test question.

20. The non-transitory computer-readable medium of claim 15, further comprising transmitting the message to a chat server including the characterbot.
